(19) United States
(12) Patent Application Publication
(10) Pub. No.: US 2008/0213328 A1
(43) Pub. Date: Sep. 4, 2008

(54) NANOSILVER-CONTAINING PRESERVATION ARTICLES, AND THE PREPARATION PROCESS AND THE USES THEREOF

(76) Inventors: Yao-Nien Chung, Kaohsiung County (TW); Pi-Ming Chu, Taipei (TW); Po-Yuan Kuo, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/040,220

(22) Filed: Feb. 29, 2008

(30) Foreign Application Priority Data
Mar. 2, 2007 (TW) 096107170

(51) Int. Cl. A01N 25/12; A01N 59/16; A01P 1/00

(52) U.S. Cl. 424/405; 424/618; 264/572; 156/245

(57) ABSTRACT

A preservation article is provided which includes nanosilver-containing anti-bacterial granules blended with plastic materials. The granules blended with the plastic materials are present in the plastic materials in an amount of 0.1 to 0.8 weight percentage based on the weight of the plastic materials.

### BACKGROUND OF THE INVENTION

1. Field of the Invention

The invention relates to nanosilver-containing preservation articles, the preparation process thereof and their uses for fresh keeping of foods and agricultural products. The nanosilver-containing preservation articles in the present invention have potent and long-lasting antibacterial and deodorizing properties. Therefore, the said articles can be used for preservation of common foods such as vegetables, fruits, seafood, meats, etc. and agricultural products such as fresh flowers and plants and in addition, they can increase the survival rates of aquaculture animals.

2. Description of the Related Art

Owing to the oxidation-reduction ability of metals, a variety of metals including silver, copper, mercury and zinc have been known for antibacterial properties. However, certain metals are overly active and may cause toxicity to humans. For example, mercury may be lethal to humans. Therefore, cautious selection of natural antibacterial materials for use in humans is necessary. Furthermore, long-term use of antibiotics as antibacterial agents has resulted in a lot of problems or has a number of disadvantages. In addition to drug resistance in bacteria easily caused by use of antibiotics, antibiotics generally exhibit antibacterial actions merely on few types of bacteria due to their different antibacterial spectrums. Besides, the antibacterial and metabolic processes of antibiotics in human or animal bodies are detrimental to viscera of the bodies. Since the treatment with metals does not lead to drug resistance in bacteria, metals have excellent properties of inhibiting bacterial growth or killing bacteria as compared with traditional antibiotics.

General antibacterial materials mainly have actions by the following mechanisms: (1) interference of cell wall synthesis by inhibiting cross-linking of polysaccharide chains with tetra-peptides in the cell walls of bacteria, which resulting in loss of the cell wall integrity and thereby loss of protection against osmotic pressure; (2) damage of cell membranes by disrupting the cell membranes to cause the death of bacteria; (3) inhibition of protein synthesis by altering or terminating the process of protein synthesis to cause the death of bacteria; (4) interference of nucleic acid synthesis by blocking the synthesis of genetic information including DNA and RNA, etc.

Among antibacterial metals, silver is considered as a safe, broad-spectrum and effective antibacterial agent. Publications have indicated that silver has natural bactericidal ability (Journal of Biomedical Materials Research 52(4): 662-8, 2000), which can kill more than 650 types of microorganisms including bacteria and viruses. After nano-treatment, the surface of silver is rapidly enlarged and the surface structure is altered, which results in increase of the bactericidal ability. Sterilization with nanosilver is based on the principle: due to the relatively strong binding ability of nanosilver particles to cell walls/membranes of microbes, the positively charged nanosilver particles adsorb to the negatively charged microbial cells after they contact with each other, the nanosilver particles then directly enter into the microbes and bind to thiol groups (—SH) of the proteases in the cell membranes, and thereby block metabolism and lead to loss of protease activity. Therefore, nanosilver can inhibit bacterial growth to achieve an antibacterial effect without causing any harm to human bodies. Furthermore, a majority of drugs may quickly vanish after they bind to bacteria. On the contrary, after eliminating bacteria, nanosilver particles do not vanish but still exist and thereby continue to have bactericidal action on the other bacteria so as to achieve a potent and long-lasting bactericidal effect. Accordingly, nanosilver can also be used for prevention of second contamination with microbes including bacteria.

Nanosilver can improve the disadvantages of traditionally used antibiotics. In addition to no occurrence of drug resistance in bacteria, nanosilver has an antibacterial action on a variety of different classes of bacteria due to its broad antibacterial spectrum. Furthermore, nanosilver is used in a relatively low dose (in micrograms) and thus does not cause toxicity to animal or human bodies. Therefore, nanosilver has been used in a variety of daily articles including fabrics (such as masks, socks, trauma dressings, etc.), housewares (such as air conditioners, washing machines, refrigerators, etc.), cosmetic or cleansing products (such as antibacterial lotions, toothpastes, etc.), construction materials (such as antibacterial furniture, etc.), or plastic articles (such as PP, PE, PET, ABS, etc.).

Different forms of silver such as liquid, powders, cross-linking mixtures, etc. have been broadly studied for use in the fields of different applications. To solve the problem that silver ions in the liquid form are not easily treated and its uses are limited, various cross-linking agents and solid supports for silver ions have been developed. For example, U.S. Pat. No. 5,824,267 discloses a plastic material having a bactericidal surface, in which a number of bactericidal particles are embedded under the condition that portion of each bactericidal particle is exposed over the surface, and the said bactericidal particle consists essentially of a ceramic or base metal particle of a mean diameter of 0.01 to 0.5 μm and silver metal particles of a mean diameter of 0.0001 to 0.1 μm fixed thereon. However, use of a solid support such as a synthetic polymeric material generally requires binding or cross-linking of silver or silver ions with the polymers, which may elicit allergic reactions in patients. Therefore, such material may not be broadly used in medicine and health care. Furthermore, due to lack of sufficient contact with bacteria, such polymeric material may not provide high bactericidal activity. In addition, as silver ions would be detached from the solid support, the bactericidal activity of the polymeric material would be quickly reduced and therefore, the said material cannot exhibit a bactericidal effect for a long period of time.

Currently, for common plastic articles comprising nanosilver, the plastic masterbatch is produced by spraying or impregnating nanosilver in a solution on the surfaces of plastic particles to form nanosilver-containing films. However, in the produced plastic masterbatch, the density of nanosilver is not high and nanosilver cannot be evenly dispersed, and the bactericidal effect is thus affected.

Furthermore, fresh keeping of fresh food such as vegetables, fruits, etc. is difficult since such food is easily decayed after being harvested. To prolong the fresh keeping period, many countries have developed numerous fresh keeping technologies, such as microwave preservation, preservation under high pressure, microbial preservation, preservation under low pressure, electronic technology preservation, or preservation by utilization of edible vegetable and fruit preservatives and hydrocarbon mixtures, etc. Additionally, plastic wrap films or bags for preservation of fresh vegetables and fruits have been developed, including a hygroscopic fresh-keeping plastic wrap film consisting of two semi-transparent nylon membranes having high water permeability between which natural pastes and sugar syrups with high osmotic pressure are filled. The said wrap films can slowly absorb water leaked from the surfaces of vegetables and fruits to achieve the fresh keeping purpose. A ceramic wrap bag has also been developed, in which the inner side of the bag is coated with a thin layer of ceramic materials. The far-infrared ray released from ceramic materials may produce resonance with water contained in vegetables or fruits, whereby improving the preservation of the fresh vegetables or fruits. However, no fresh-keeping article containing specially treated nanosilver has been seen in the current market.

Furthermore, commercially available fresh-keeping articles cannot provide long preservation and fresh keeping effects for foods and agricultural products, nor can they increase the survival rate of the aquaculture animals. Accordingly, there is a high need for preservation articles having excellent bactericidal and deodorizing activity and being safe to the environment.

### BRIEF SUMMARY OF THE INVENTION

The invention relates to nanosilver-containing preservation articles, the preparation process thereof and their uses for fresh keeping of foods and agricultural products.

### BRIEF DESCRIPTION OF THE DRAWINGS

FIG. 1 is photographs showing fresh keeping test results of the fresh salmon samples in the nanosilver-containing preservative bag of the present invention and the commercially available sealable bag after refrigeration at 4° C. for certain days.

FIG. 2 is photographs showing fresh keeping test results of the fresh cake samples in the nanosilver-containing preservative bag of the present invention and the commercially available sealable bag after refrigeration at 4° C. for certain days.

FIG. 3 is photographs showing fresh keeping test results of the fresh spinach samples in the nanosilver-containing preservative bag of the present invention and the commercially available sealable bag after refrigeration at 4° C. for certain days.

FIG. 4 is photographs showing fresh keeping test results of the fresh wax apple samples in the nanosilver-containing preservative bag of the present invention and the commercially available sealable bag after refrigeration at 4° C. for certain days.

FIG. 5 is photographs showing deodorizing test results of the fresh fish samples in the nanosilver-containing preservative bag of the present invention and the commercially available sealable bag after refrigeration at 4° C. for certain days.

FIG. 6 is photographs showing deodorizing test results of the fresh crab leg samples in the nanosilver-containing preservative bag of the present invention and the commercially available sealable bag after refrigeration at 4° C. for certain days.

FIG. 7 is a curve graph showing the antibacterial effects of the nanosilver-containing preservative bag of the present invention and the commercially available sealable bag on putrefying bacteria in yellow croakers.

FIG. 8 is a curve graph showing the antibacterial effects of the nanosilver-containing preservative bag of the present invention and the commercially available sealable bag on bacteria in cod fish.

### DETAILED DESCRIPTION OF THE INVENTION

In one aspect of the invention, the present invention relates to a preservation article comprising nanosilver granules blended with plastic materials, in which the nanosilver granules in an amount of 0.1 to 0.8 wt % are present in the said plastic materials. The nanosilver granules can be present in different sizes and shapes depending on desired purposes. The nanosilver granules in the preservation articles of the present invention do not show migration and have bactericidal and deodorizing effects. Therefore, the said articles can provide long-term fresh keeping and deodorizing effects for foods and agricultural products including vegetables and fruits.

The nanosilver contained in the preservation articles of the present invention is present in the form of granules. In the nanosilver-containing antibacterial granules (NAGs) of the present invention, the nanosilver particles are firmly and evenly attached to the stalk marrow of Juncus effusus L. The diameter of the nanosilver particles is about 1 to 100 nm, and the individual nanosilver particle has a metallic silver core surrounded by silver oxide.

The nanosilver-containing antibacterial granules (NAGs) in the present invention are produced by the process comprising the following steps: (1) cutting the stalk marrow of Juncus effusus L. into pieces; (2) immersing the cut stalk marrow in a solution containing nanosilver particles to allow the attachment of the nanosilver particles to the cut stalk marrow; (3) after the attachment, optionally washing the cut stalk marrow with hot and cold water; (4) drying the nanosilver particles-attached stalk marrow; and (5) grinding the nanosilver particles-containing stalk marrow to appropriate size to produce the NAGs.

In a preferred embodiment, the nanosilver-containing antibacterial granules (NAGs) of the present invention are produced by the process comprising the following steps: (1) cutting the stalk marrow of Junicus effusus L. into pieces (about 0.5 to 2 cm at length); (2) preparing nanosilver particles-containing solution; (3) immersing the cut stalk marrow in a solution containing nanosilver particles to allow the attachment of the nanosilver particles to the cut stalk marrow pieces; (4) washing the cut stalk marrow pieces (preferably first with hot water, then with cold water); (5) drying the cut stalk marrow pieces; and (6) grinding the dried cut stalk marrow pieces to the desirable sizes of the NAGs. The NAGs preferably have a size capable of passing through a No. 200 sieve. Furthermore, the cut stalk marrow pieces can be boiled to remove the unwanted water soluble materials, followed by heating drying the boiled stalk marrow pieces and then soaking the stalk marrow pieces in the nanosilver-containing solution. Preferably, the nanosilver soaked stalk marrow pieces are treated with heat until the stalk marrow pieces turn brown, and then the stalk marrow pieces is washed with hot and cold water.

In the nanosilver-containing antibacterial granules (NAGs) of the present invention, the nanosilver particle-containing solution is prepared by dissolving silver nitrate in ammonia water and in turns adding a reducing agent and oxidizing agent to the solution. Optionally, NaOH can be added to the solution to adjust the pH, and ethanol can be added to the solution to improve the solubility of the solution. A preferred reducing agent is glucose or ascorbic acid, and a preferred oxidizing agent is hydrogen peroxide.

In a preferred embodiment, the nanosilver solution is prepared by the process comprising the following steps: (1) dissolving silver nitrate (AgNO₃) crystals in an ammonia water solution; (2) adding glucose or ascorbic acid as a reducing agent to the solution; and (3) adding an oxidizing agent (preferably hydrogen peroxide) to the solution. Optionally, NaOH and ethanol can be added to the nanosilver solution to adjust the pH and improve the solubility of the nanosilver solution.

The nanosilver-containing antibacterial granules (NAGs) of the present invention are prepared by attaching nanosilver particles to small pieces of the stalk marrow of the plant Juncus effusus L. The attachment of nanosilver particles can be confirmed by scanning electromicroscopy using AMRAY1910FE and TN-8502, which shows that the nanosilver particles on the NAGs are about 25 nm in diameter and are evenly distributed on the NAGs. The contents of the nanosilver particles in the NAGs are about 20 to 100 mg per gram of the NAGs, which were analyzed by a silver titrimetric method.

In another aspect of the present invention, the present invention also relates to a process for preparing nanosilver-containing preservation articles, which comprises blending the nanosilver-containing antibacterial granules with plastic materials to allow the granules to be evenly distributed on the said materials, followed by performing a traditional molding process to prepare a variety of preservation articles in different forms, such as preservative films, preservative bags, preservative boxes, etc. The plastic materials used in the process of the present invention include but not limited to ABS, PE, PP, PS, PET, PC, DPP, CPP, etc.

In another preferred embodiment, the nanosilver-containing preservation articles prepared by the process of the present invention are preservative films/bags prepared by blending the nanosilver-containing antibacterial granules (NAGs) with plastic materials, followed by subsequent processing. In the said process, the nanosilver-containing antibacterial granules in an amount of 0.1 to 0.8 wt % based on the weight of plastic materials are used to be uniformly blended with the plastic materials, which allows nanosilver to be evenly distributed on the plastic materials and thereby achieves the bactericidal effect of nanosilver through contact. The resultant blends then form films by a general extrusion or blow molding process and thereafter the films are folded and/or cut into bags depending on the required specification.

In another embodiment of the present invention, the nanosilver-containing antibacterial granules are added in an amount of 0.4 wt % for blending with the plastic materials, and the produced preservative films have the thickness of from about 0.02 mm to 0.15 mm.

In another embodiment, the molding processes used in the process for preparing nanosilver-containing preservation articles include lamination and coating techniques, in which the plastic materials used include PE, PP, PET, OPP, CPP and VMPET. Preferably, the thickness of the preservative films on the products prepared by the said process is from 0.025 mm to 0.2 mm.

In the process for preparing nanosilver-containing plastic films of the present invention, the nanosilver-containing antibacterial granules are thoroughly blended with plastic materials and then the resulted blends form films by extrusion or blowing molding, which is different from the conventional procedure that a final product is produced and then coated with a nanosilver solution thereon. Therefore, the preservation articles prepared by the process of the present invention have excellent properties advantageous over the prior art. Namely, the nanosilver granules in the present invention are evenly distributed on the plastic materials and have a larger surface exposed to sufficiently contact with bacteria, whereby having both bactericidal and deodorizing effects. In addition, the nanosilver granules do not show migration and would not be released from plastic films and therefore, they are safe to the environment.

The nanosilver-containing preservation articles of the present invention have broad applications. Therefore, another aspect of the present invention relates to the use of the nanosilver-containing preservation articles of the present invention for preservation of foods and agricultural products. Due to the dual bactericidal and deodorizing effects, the preservation articles of the present invention are effective in prolonging eating and fresh keeping periods. In an embodiment, the preservation articles of the present invention are used for preservation of fresh foodstuffs and foods, especially those that are easily decayed or not easily kept fresh, such as vegetables, fruits, seafood, meats, breads, cakes, etc. In average, use of the preservation articles of the present invention can increase the fresh keeping period for five days to one month.

For fresh vegetables and fruits, the nanosilver-containing preservative bags of the present invention exhibit a greatest effect on fresh keeping of dark green and easily perishable vegetables such as green onion, spinach, coriander, etc., which have the fresh keeping period one week to one month longer than commercially available zipper bags. The said nanosilver-containing preservative bags show a mediate effect on fresh keeping of the other non-dark green vegetables, which increase the fresh keeping period for about one week to ten days. For the melons such as green pepper, cucumber, etc., the fresh keeping period can be increased for about 5 to 7 days. Furthermore, for fresh keeping of general fruits, commercially available preservative bags only increase the fresh keeping period of wax apples for about 4 days, while the nanosilver-containing preservative bags of the present invention increase the said fresh keeping period to up to 10 days. In addition, for fresh keeping of fish such as salmon at the temperature of 4° C., apparent odor is present and fish lose elasticity on the day 3 after using commercially available zipper bags. On comparison, apparent odor is present and fish lose elasticity on the day 10 after using the nanosilver-containing preservative bags of the present invention. Therefore, the preservative bags of the present invention can increase the fresh keeping period for about 7 days.

Moreover, the nanosilver-containing preservative bags of the present invention exhibit antibacterial effects on putrefactive bacteria (such as Staphylococcus aureus) in fish. Namely, the said preservative bags have antibacterial effects about 10-fold higher than the commercially available preservative bags on day 3.

In another aspect, the nanosilver-containing preservation articles of the present invention can be also used for preservation of agricultural products such as fresh flowers and other plants. In one embodiment, the nanosilver-containing PE films of the present invention can be applied for fresh keeping of flowers (including cut flowers and potted flowers). The nanosilver-containing PE films of the present invention together with non-woven fabrics produce cover bags having a big upper opening and a small lower opening, wherein the flowers are positioned adjacent to the said upper opening and the lower stems are positioned adjacent to the said lower opening. When fresh flowers are packed by the nanosilver-containing cover bags of the present invention, the nanosilver-containing PE films are placed on the front side which allows the bactericidal action to prevent fresh flowers from early wilting and allows for clear observation of the condition of the fresh flowers, and the non-woven fabrics are positioned on the back side of the said cover bag which protect the flowers from damage caused by collision. Therefore, the preservative films of the present invention can be used for delaying deterioration of cut flowers in vase, including softening of flower stalks, abscission of flower petals and rotting of flower stems, thereby elongating the vase life of the flowers.

In a further aspect, the nanosilver-containing preservation articles of the present invention can be applied to water sterilization in the aquaculture industry. In an embodiment, the nanosilver-containing PE preservative films can be used for reducing pests and thereby increasing the survival rate of aquaculture animals.

### EXAMPLES

The following examples are used to illustrate the technical content of the present invention and the efficacy to be achieved, but not used to limit the present invention. Any equivalent changes and modifications made according to the invention are all within the scope of the claims of the invention.

The nanosilver-containing antibacterial granules (NAGs) were produced according to the method described in U.S. Pat. No. 6,379,712. For preparation of the preservative bags or films comprising the said nanosilver-containing antibacterial granules, 0.4 wt % of the NAGs was used to be thoroughly blended with PE materials (18 tons/day) so that nanosilver can be evenly distributed on the PE materials and thereby provides a bactericidal effect of nanosilver. Thereafter, the resulted blend forms films by a blow molding process using a blow molding machine at the temperature of 150-220° C., and the thickness of the said films is about 0.02 mm to 0.15 mm. The said films were then cut to form bags depending on the required sizes, namely the preservative bags of the present invention.

### Example 1

### Fresh Keeping Test of the Nanosilver-Containing Preservative Bags

This example was to test the fresh keeping ability of the nanosilver-containing preservative bag of the present invention for salmons, cakes, spinach and wax apples, which was performed in a 10-day sensation evaluation by 5 volunteers. The preservative bag of the control group was purchased from commercially available sealable bags.

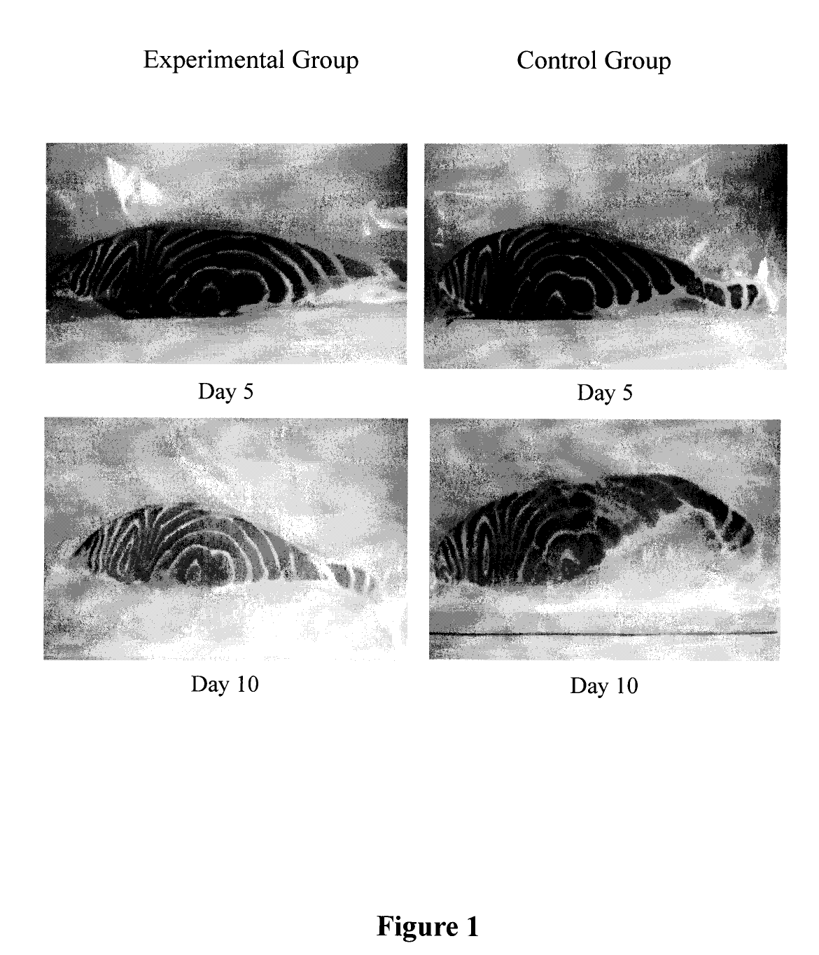

To perform the fresh keeping test of human sensation, the fresh salmon, cake, spinach and wax apple samples were respectively placed in the nanosilver-containing preservative bag of the present invention (experimental group) and the commercially available sealable bag (control group) and were then stored in the refrigerator at 4° C. Thereafter, the five volunteers observed the changes of the salmon and cake samples on day 1, 3, 5, 8 and 10, respectively, and observed the changes of the spinach and wax apple sample on day 1, 4, 7 and 10, respectively. The results were recorded and shown in Tables 1 to 4 and FIGS. 1 to 4 below.

TABLE 1
The test of fresh keeping ability for fish

Test group

| Test day | Experimental group | Control group |
|---|---|---|
| Day 1 | Fish having elasticity and | Fish having elasticity and |
| | no odor | no odor |
| Day 3 | Fish having elasticity and | Fish having no elasticity |
| | no odor | and slight odor |
| Day 5 | Fish having less elasticity | Fish having no elasticity |
| | and slight odor | and having odor |
| Day 8 | Fish having less elasticity | Fish having no elasticity |
| | and slight odor | and having heavy odor |
| Day 10 | Fish having no elasticity | Fish having no elasticity |
| | and having odor | and having heavy odor |

TABLE 2
The test of fresh keeping ability for cakes

Test group

| Test day | Experimental group | Control group |
|---|---|---|
| Day 1 | Cake having spongy and | Cake having spongy and |
| | soft texture | soft texture |
| Day 3 | Cake having spongy and | Cake having spongy and |
| | soft texture | soft texture |
| Day 5 | Cake having spongy and | Cake having spongy and |
| | soft texture | soft texture |
| Day 8 | Cake having spongy and | Cake having less spongy |
| | soft texture | and soft texture |
| Day 10 | Cake having spongy and | Cake having less spongy |
| | soft texture | and soft texture |

TABLE 3
The test of fresh keeping ability for spinach

| | Test group | |
|---|---|---|
| Test day | Experimental group | Control group |
| Day 1 | Leaves and root being both | Leaves and root being both |
| | clear green | clear green |
| Day 4 | Leaves and root being both | Leaves and root being both |
| | clear green | clear green |
| Day 7 | Leaves and root being both | Leaves being partially rotten |
| | clear green | and root being clear green |
| Day 10 | Leaves being partially rotten | Leaves being partially rotten |
| | and root being clear green | and root being clear green |

TABLE 4
The test of fresh keeping ability for wax apples

| | Test group | |
|---|---|---|
| Test day | Experimental group | Control group |
| Day 1 | Two wax apples having full | Two wax apples having full |
| | and round bodies | and round bodies |
| Day 4 | One of the two wax apples | Both of the two wax apples |
| | having a rotten appearance | having rotten appearances |
| Day 7 | Both of the two wax apples | Both of the two wax apples |
| | having rotten appearances: | having rotten appearances: |
| | both having a rotten area less | one having a rotten area over |
| | than ⅓ of their surfaces | ⅓ of the surface |
| Day 10 | Both of the two wax apples | Both of the two wax apples |
| | having rotten appearances: | having rotten appearances: |
| | one having a rotten area of | both having a rotten area over |
| | about ⅓ of the surface, and | ⅓ of the surface |
| | the other one having a rotten | |
| | area less than ⅓ of the | |
| | surface | |

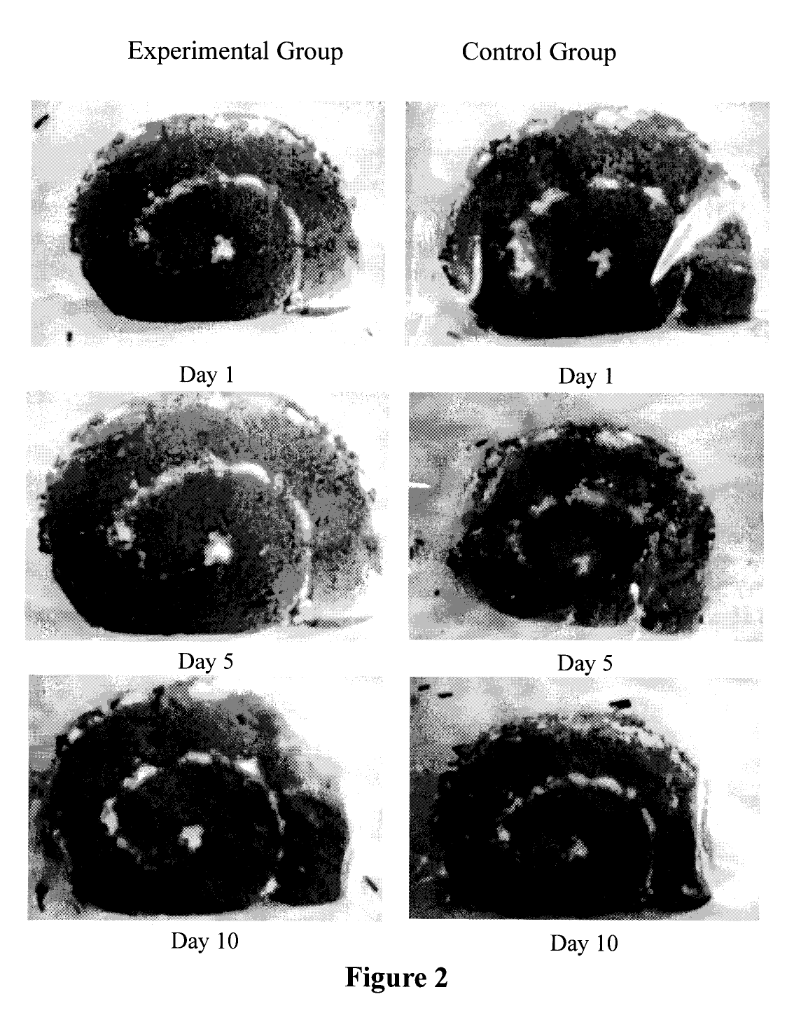

The results showed that as compared with the control group, the nanosilver-containing preservative bag of the present invention has a superior fresh keeping ability on salmon on day 3 in terms of fish elasticity. That is, the fish in the control group had odor and no elasticity on day 3 and had heavy and stinking smell occurring on day 10, while the fish in the nanosilver-containing preservative bag of the present invention had slight odor on day 5 and had heavier odor and no elasticity occurring until day 10 (as shown in Table 1 and FIG. 1). Furthermore, the nanosilver-containing preservative bag of the present invention was different from the control group in fresh keeping of cakes. Namely, the cake in the control group was less elastic than that in the nanosilver-containing preservative bag of the present invention on day 8. On day 10, the cake had a less spongy and soft texture, while the cake in the nanosilver-containing preservative bag of the present invention still maintain a spongy and soft state (as shown in Table 2 and FIG. 2).

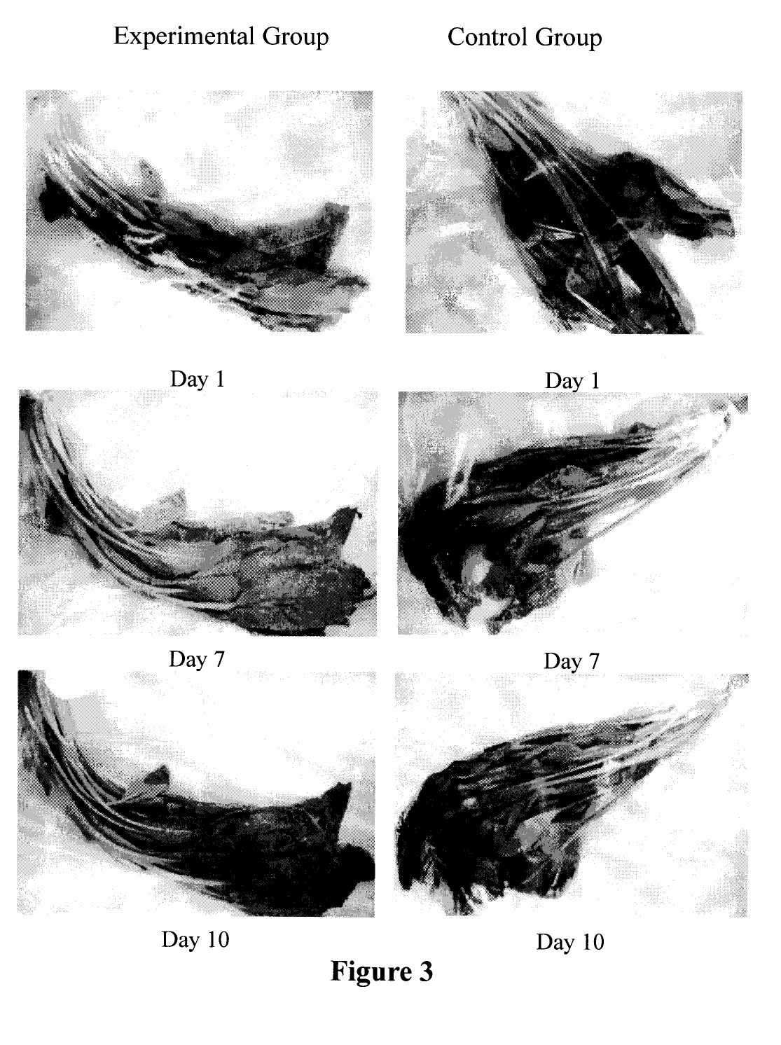

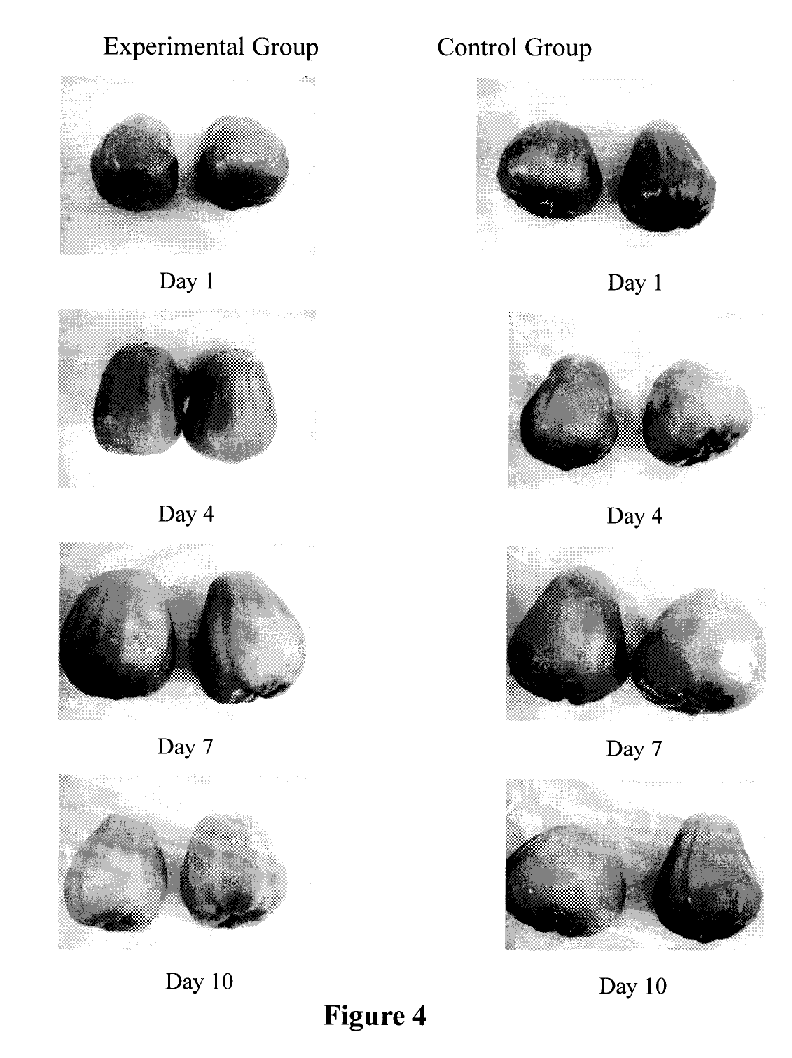

In fresh keeping of spinach, the spinach stems in the nanosilver-containing preservative bag of the present invention and the control group did not have any rotten appearance within 10 days. However, the leaves in the control group were partially rotten on day 7, while the leaves in the experimental group appeared to be partially rotten on day 10 (as shown on Table 3 and FIG. 3). Furthermore, the fresh keeping ability of the nanosilver-containing preservative bag of the present invention for wax apples was different from the control group on day 4. Namely, one of the two wax apples of the experimental group had a rotten appearance in a small part, while the two wax apples of the control group both showed rotten appearances. On day 7, the other wax apple of the experimental group started to show a rotten appearance but the area is less than ⅓ of the surface, while one of the two wax apples of the control group had a rotten appearance over ⅓ of the surface. On day 10, the two wax apples of the control group both had rotten areas over ⅓ of their surfaces, while only one wax apple of the experimental group had a rotten appearance of about ⅓ of the surface (as shown in Table 3 and FIG. 4).

### Example 2

### Deodorizing Test of the Nanosilver-Containing Preservative Bags

This example was to test the deodorizing ability of the nanosilver-containing preservative bags of the present invention for fish and crab legs, which was performed in a 10-day sensation evaluation by 5 volunteers. The preservative bag of the control group was purchased from commercially available sealable bags.

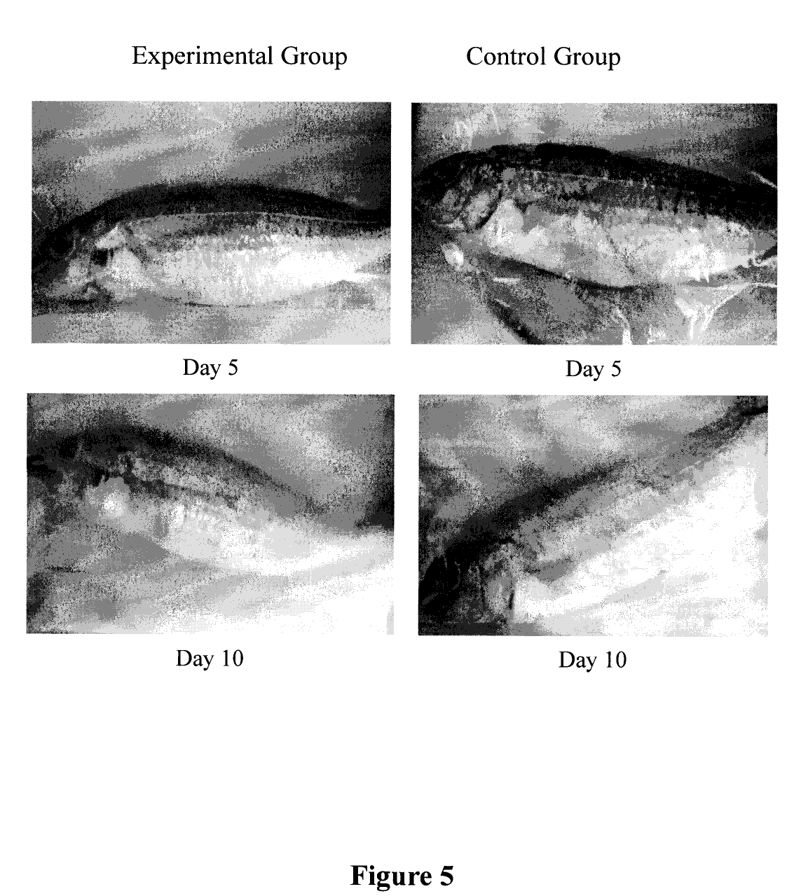

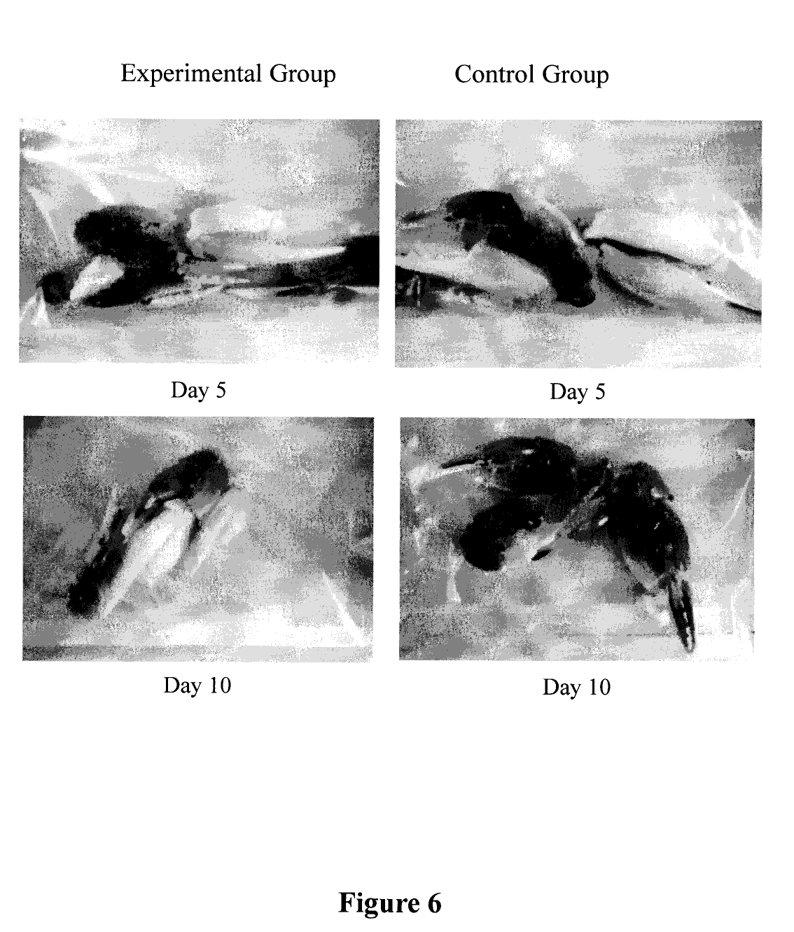

To perform the deodorizing test of human sensation, the fresh fish and crab leg samples were respectively placed in the nanosilver-containing preservative bag of the present invention (experimental group) and the commercially available sealable bag (control group) and were then stored in the refrigerator at 4° C. Thereafter, the five volunteers observed the changes of the samples on day 1, 3, 5, 8 and 10, respectively. The results were recorded and shown in Table 5 and FIGS. 5 and 6 below.

TABLE 5
The test of deodorizing ability for fish and crab legs

| | Test group | |
|---|---|---|
| Test day | Experimental group | Control group |
| Day 1 | Fish having elasticity, and | Fish having elasticity, and |
| | fish and crab legs both | fish and crab legs both |
| | having no odor | having no odor |
| Day 3 | Fish having elasticity, and | Fish having no elasticity, |
| | fish and crab legs both | and fish and crab legs both |
| | having no apparent odor | having slight odor |
| Day 5 | Fish having less elasticity, | Fish having no elasticity, |
| | and fish and crab legs both | and fish and crab legs both |
| | having slight odor | having odor |
| Day 8 | Fish having no elasticity, | Fish having no elasticity, |
| | and fish and crab legs both | and fish and crab legs both |
| | having slight odor | having odor |
| Day 10 | Fish having no elasticity, | Fish having no elasticity, |
| | and fish and crab legs both | and fish and crab legs both |
| | having odor | having odor |

The results showed that the deodorizing ability of the nanosilver-containing preservative bags of the present invention for fish and crab legs was slightly different from the control group on day 3. Apparent odor occurred in the control group on day 3, while slight odor was present in the nanosilver-containing preservative bags of the present invention on day 5 (as shown in FIGS. 5 and 6).

### Example 3

### Antibacterial Test of the Nanosilver-Containing Preservative Bags for Fish

### 1. Antibacterial Effect on Putrefying Bacteria in Yellow Croakers

The bacterial strain tested in the antibacterial ability test was Staphylococcus aureus ATCC 25923. The said strain was inoculated in a Trypticase Soy Agar (TSA) medium containing 5% sheep blood. The Staphylococcus aureus colonies were picked up to form a solution containing bacterial concentration of McFarland 0.5 (about 1.5×10⁸ CFU/ml), which was then serial diluted in Mueller-Hinton Broth for 10,000× dilution (namely, the expected bacterial count was about 1.5×10⁴ CFU/ml).

Two fifty-gram samples were taken from the yellow croakers purchased from the supermarket and respectively placed in the nanosilver-containing preservative bag of the present invention (experimental group) and the commercially available sealable bag (control group), followed by addition of 450 ml of phosphate buffer solution. After being thoroughly mixed in a stomacher, 1 ml of the solution containing 1.5×10⁴ CFU/ml Staphylococcus aureus was added to the two bags, respectively. The total bacterial counts in the yellow croaker samples on day 0 were determined after inoculation on the TGEA medium.

The two bags containing the samples inoculated with Staphylococcus aureus were placed in the refrigerator at 4° C. The total bacterial counts in the samples on day 3, 5 and 7 were respectively determined based on the above-mentioned method, and the abilities of the nanosilver-containing preservative bag of the present invention and the commercially available sealable bag for bacterial inhibition were compared.

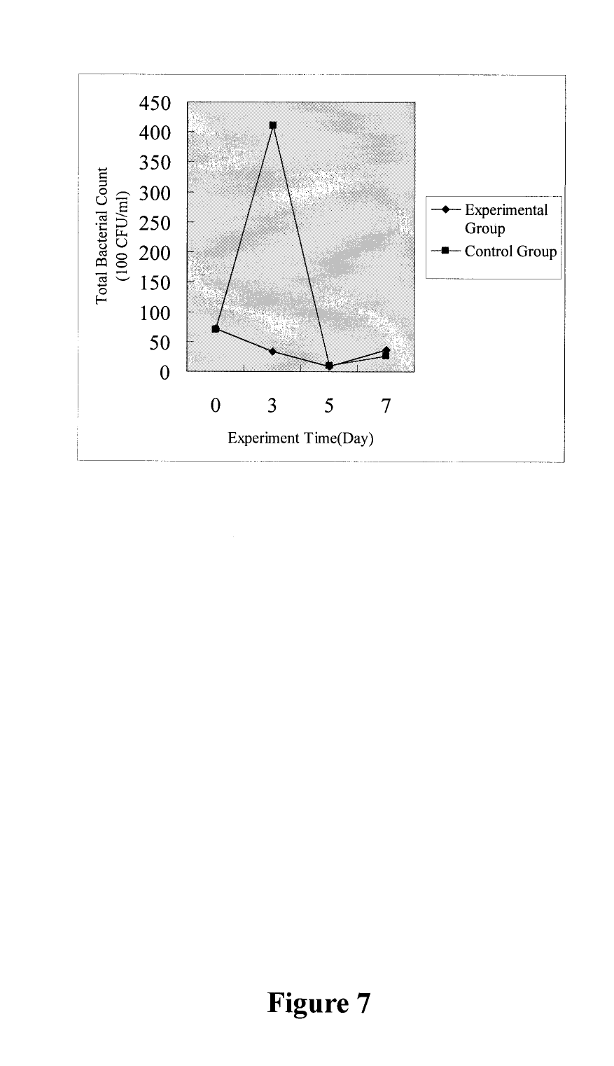

The results of the antibacterial test were shown in Table 6 and FIG. 7 below.

TABLE 6
The test of antibacterial ability for the putrefying bacteria in
yellow croacker

Test group

| | Bacterial count of the | Bacterial count of the |
|---|---|---|
| | experimental group | control group |
| Test day | (CFU/ml) | (CFU/ml) |
| Day 0 | 7.1 × 10³ | 7.0 × 10³ |
| Day 3 | 3.3 × 10³ | 4.1 × 10³ |
| Day 5 | 8.5 × 10² | 1.0 × 10³ |
| Day 7 | 3.6 × 10³ | 2.6 × 10³ |

The results showed that the initial bacterial counts of the experimental group and control group were both about 7.0×10³ CFU/ml. On day 3 of the experiment, the total bacterial counts of the experimental group and control group were 3.3×10³ and 4.1×10³ CFU/ml, respectively. The bacterial count of the experimental group was about 10 times lower than the control group. However, on day 5, the total bacterial counts of the experimental group and control group were decreased to 8.5×10² and 1.0×10³ CFU/ml, respectively. On day 7, the bacterial counts of the experimental group and control group were both increased. Therefore, as compared with the commercially available preservative bag, the nanosilver-containing preservative bag of the present invention had a better antibacterial effect on the putrefying bacteria in the yellow croaker (i.e. Staphylococcus aureus) within five days.

### 2. Antibacterial Effect on Putrefying Bacteria in Cod Fish

In the antibacterial ability test, two samples of 200 g of commercially available cod fish were respectively placed in the nanosilver-containing preservative bag of the present invention (experimental group) and the commercially available sealable bag (control group) and stored at 5° C. The total bacterial counts in the fish samples on day 0, 3, 5 and 7 were determined. Microbial determination was performed by adding 225 g of sterile water to 25 g of fish samples and being homogenized, followed by incubation of 1 ml of the appropriately serial diluted solution on 3M Petrifilm™ at 37° C. for 48 hours and then counting bacterial colonies.

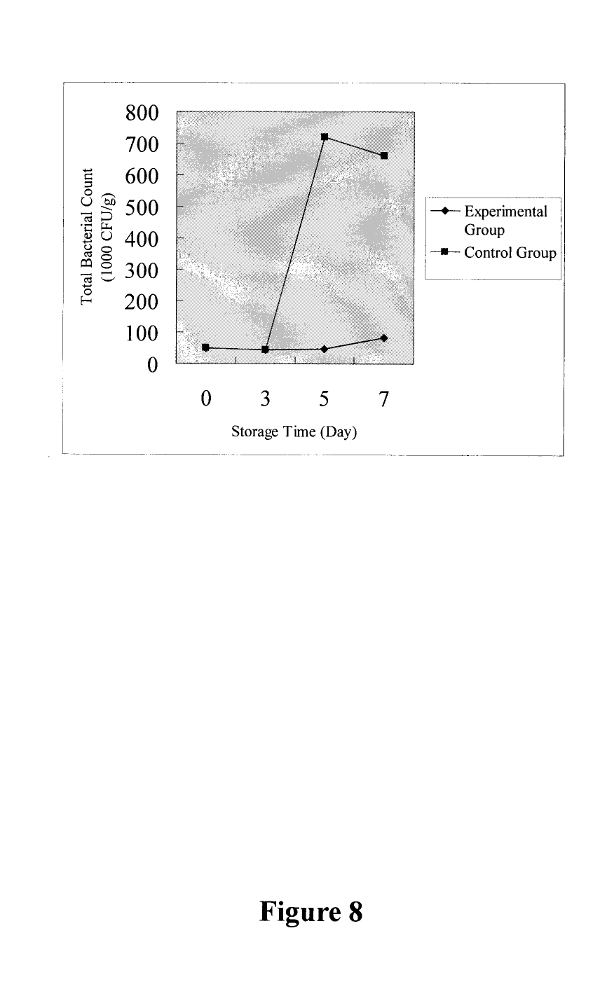

The results of the antibacterial test were shown in Table 7 and FIG. 8 below.

TABLE 7
The test of antibacterial ability in cod fish

| | Test group | |
|---|---|---|
| | Total bacterial count of the | Total bacterial count of the |
| | experimental group | control group |
| Test day | (CFU/g) | (CFU/g) |
| Day 0 | 5.1 × 10⁴ | 5.1 × 10⁴ |
| Day 3 | 4.4 × 10⁴ | 4.4 × 10⁴ |
| Day 5 | 4.7 × 10⁴ | 7.2 × 10⁵ |
| Day 7 | 8.2 × 10⁴ | 6.6 × 10⁵ |

The results showed that the total bacterial counts of the experimental group and control group were both about 5.1×10³ CFU/g initially and 4.4×10⁴ CFU/g on day 3. On day 5 of the experiment, the total bacterial count of the experimental group was 4.7×10⁴ CFU/g, while the total bacterial count of the control group were increased to 7.2×10⁵ CFU/g. Therefore, the total bacterial count of the experimental group was about 15 times lower than the control group. On day 7, the total bacterial counts of the experimental group and control group were 8.2×10⁴ and 6.6×10⁵ CFU/g, respectively, which shows that the antibacterial effect of the experimental group was still better than the control group. Therefore, as compared with the commercially available preservative bag, the nanosilver-containing preservative bag of the present invention had a better antibacterial effect on the bacteria in the cod fish (i.e. Staphylococcus aureus) within seven days.

### Example 4

### Silver Migration Test

This test is to determine whether silver contained in the nanosilver-containing preservative bag of the present invention is released therefrom. Based on the standard analysis method (NIEA W306.52A) published by Environmental Protection Administration, Executive Yuan, R.O.C., 95° C. water was poured into the nanosilver-containing preservative bag of the present invention and, after three hours, silver content was detected by an atomic absorption spectrophotometer. The detection value MDL=0.06 was obtained, which is apparently lower than the detection limit and shows that nanosilver contained in the nanosilver-containing preservative bag of the present invention was not released from the PE film or dissolved due to heating. Therefore, the nanosilver-containing preservative bag of the present invention is safe to the environment.

We claim:

1. A preservation article comprising nanosilver-containing antibacterial granules (NAGs) blended with plastic materials, wherein said granules are present in an amount of 0.1 to 0.8 wt % based on the weight of the said plastic materials.

2. A preservation article according to claim 1, wherein the nanosilver particles in the said nanosilver-containing antibacterial granules are firmly and evenly attached to the stalk marrow of Juncus effusus L.

3. A preservation article according to claim 2, wherein each of the said nanosilver particles has a metallic silver core surrounded by silver oxide.

4. A preservation article according to claim 1, wherein each of the said nanosilver particles has a diameter of about 1 to 100 nm.

5. A preservation article according to claim 1, wherein the said nanosilver-containing antibacterial granules are produced by the process comprising the following steps: (1) cutting the stalk marrow of Juncus effusus L. into pieces; (2) immersing the cut stalk marrow in a solution containing nanosilver particles to allow the attachment of the nanosilver particles to the cut stalk marrow; (3) after the attachment, optionally washing the cut stalk marrow with hot and cold water; (4) drying the nanosilver particles-attached stalk marrow; and (5) grinding the nanosilver particles-containing stalk marrow to appropriate size to produce the said nanosilver-containing antibacterial granules.

6. A preservation article according to claim 1, wherein the said nanosilver-containing antibacterial granules are present in an amount of 0.4 wt % in the said plastic materials.

7. A preservation article according to claim 1, wherein the said plastic materials blended with the said nanosilver-containing antibacterial granules are selected from the group consisting of ABS, PE, PP, PS, PET, PC, DPP and CPP.

8. A preservation article according to claim 7, wherein the said plastic materials are PE.

9. A preservation article according to claim 1, which is selected from the group consisting of preservative films, preservative bags and preservative boxes.

10. A preservation article according to claim 9, wherein the said preservative films or preservative bags are prepared by blending 0.1 to 0.8 wt % of the said nanosilver-containing antibacterial granules with PE materials.

11. A preservation article according to claim 10, wherein the said preservative films or preservative bags are prepared by blending 0.4 wt % of the said nanosilver-containing antibacterial granules with PE materials.

12. A preservation article according to claim 9, wherein the blends prepared by blending the said nanosilver-containing antibacterial granules with the PE materials form preservative films by a blow molding process.

13. A preservation article according to claim 12, wherein the said preservative films are folded and/or cut into preservative bags.

14. A preservation article according to claim 9, wherein the said preservative films have the thickness of from about 0.02 mm to 0.15 mm.

15. A process for preparing nanosilver-containing preservation articles, which comprises blending the nanosilver-containing antibacterial granules (NAGs) with plastic materials to allow the granules to be evenly distributed on the said materials, followed by performing a molding process to prepare the said nanosilver-containing preservation articles.

16. A process according to claim 15, wherein the said preservation articles are selected from the group consisting of preservative films, preservative bags, preservative boxes.

17. A process according to claim 15, wherein the said plastic materials are selected from the group consisting of ABS, PE, PP, PS, PET, PC, DPP and CPP.

18. A process according to claim 16, wherein the said nanosilver-containing preservation articles are preservative films or preservative bags.

19. A process according to claim 18, wherein the said preservative films are produced by thoroughly blending 0.1 to 0.8 wt % of the nanosilver-containing antibacterial granules (NAGs) with PE materials and blow molding the resulted blends.

20. A process according to claim 19, wherein the amount of the said nanosilver-containing antibacterial granules added for blending with PE is 0.4 wt %.

21. A process according to claim 19, wherein the thickness of the preservative films produced is from about 0.02 mm to 0.15 mm.

22. A process according to claim 19, wherein the said preservative films are folded and/or cut into bags depending on the required specification.

23. A process according to claim 15, wherein the said molding process includes lamination and coating procedure.

24. A process according to claim 23, wherein the plastic materials used includes PE, PP, PET, OPP, CPP and VMPET.

25. A process according to claim 23, wherein the thickness of the preservative films on the product is from 0.025 nm to 0.2 nm.

26. Use of the preservation article of claim 1 for preservation of foods and agricultural products.

27. Use according to claim 26, wherein the said preservation article is selected from the group consisting of preservative films, preservative bags, preservative boxes.

28. Use according to claim 26, wherein the said foods include fresh foodstuffs and fresh foods.

29. Use according to claim 28, wherein the said foods include vegetables, fruits, seafood, meats, breads and cakes.

30. Use according to claim 26, wherein the said preservation articles are PE preservative films.

31. Use according to claim 26, wherein the said agricultural products include fresh flowers and other plants.

32. Use according to claim 23, wherein the said fresh flowers include cut flowers and potted flowers.

33. Use according to claim 30, wherein the said PE preservative films together with non-woven fabrics form cover bags having a large upper opening and a small lower opening for packing fresh flowers.

34. Use according to claim 33, wherein the said PE preservative films are placed on the front side of the bag which allows bactericidal action for preventing early wilting of the fresh flowers, and the non-woven fabrics are positioned on the back side of the said cover bag to protect the flowers from damage caused by collision.

35. Use the preservation article of claim 1 for increasing the survival rate of aquaculture animals.
